(19) United States
(12) Patent Application Publication
(10) Pub. No.: US 2023/0304424 A1
(43) Pub. Date: Sep. 28, 2023

(54) RESIDUE CONTAINMENT

(71) Applicant: DEUTZ Aktiengesellschaft, Koeln (DE)

(72) Inventors: Andreas BOEMER, Koeln (DE); Werner LEMME, Roesrath (DE)

(21) Appl. No.: 17/276,919

(22) PCT Filed: Aug. 22, 2019
(86) PCT No.: PCT/EP2019/000243

§ 371 Date: Aug. 30, 2021

(30) Foreign Application Priority Data
Sep. 26, 2018 (DE) 10 2018 007 604.1

(51) Int. Cl. F01M 11/00; F01M 11/03

(52) U.S. Cl. CPC F01M 11/0004; F01M 11/03; F01M 2011/0029; F01M 2011/0037

(57) ABSTRACT

An internal combustion engine is provided, including at least one crankcase, at least one oil pump, at least one oil filter, at least one oil circuit, at least one control valve, and at least one device for separating particulate contaminants from a fluid flow, in particular for separating contaminants from the crankcase of the internal combustion engine, this fluid or oil flow to be purified having at least one containment for receiving the contaminants.

### DESCRIPTION

The present invention relates to a CAN communication protocol system, along with an internal combustion engine and a method for operating same, for exchanging fuel consumption-optimizing and/or operating fluid consumption-optimizing and noise-optimizing messages between drive components and output components, which also help to increase the overall availability of the system.

The present invention relates to an internal combustion engine including a residue containment.

### BACKGROUND

A method and a device for separating contaminants from a gas flow are known from DE 102007025416 B3.

An intake manifold for engine oil is further known from EP 1857646 B1.

The oil circuit of an internal combustion engine normally includes an oil pressure control valve. The latter controls downstream from the oil cooler the oil quantity that is not needed for the engine lubrication back into the oil pan.

If the oil pressure control valve is kept open as a result of an error, the lubricating oil circuit is disrupted and the locations to be lubricated receive too little oil pressure. Such an error may occur due to contaminants (machining chips, casting sand residues, blasting shot, etc.) in the oil. The removal of these contaminants after casting and machining is difficult despite cleaning with the aid of high-pressure machines, so that a certain amount always remains in the fully assembled internal combustion engine.

As a result of the position of the control valve in the oil circuit, the purging of the valve seat during engine operation and thus the susceptibility to disruption may be influenced.

It is also possible to position the valve downstream from the lubricating oil filter, so that contaminants cannot reach the valve. This, however, has the disadvantage, for example, that the filter size must increase, since the entire conveyed oil quantity and not just the lubricating oil quantity flows through the filter and the filter lifetime is otherwise reduced accordingly.

In some installation cases, the valve is positioned in the oil circuit laterally next to the oil filter, figuratively speaking in an “appendix,” so that once the contaminants reach the valve, they are no longer eliminated through the oil flow, but are deposited upstream from the valve seat and remain stuck in the valve seat upon opening the valve, whereby the valve may be prevented from closing.

### SUMMARY OF THE INVENTION

It is an object of the present invention to create an internal combustion engine and a method that prevent the above-mentioned disadvantages.

The present invention provides an internal combustion engine including a crankcase, at least one oil pump, at least one oil filter, at least one oil circuit, at least one control valve, and at least one device for separating particulate contaminants from a fluid flow, in particular for separating contaminants from the crankcase of the internal combustion engine, this fluid or oil flow to be purified having at least one containment for receiving the contaminants. It is advantageous in this case that the contaminants may be permanently stored in the provided containment.

Further features of the present invention result from the following description and the figures or the table, each illustrating one exemplary embodiment.

### BRIEF DESCRIPTION OF THE DRAWINGS

FIGS. 1a and 1b show different views of a crankcase having an appendix-like oil line and the top view of the appendix,

FIGS. 2a and 2b show different views of a crankcase having an appendix-like oil line and the top view of the appendix as well as two containments for receiving contaminants,

FIG. 3 shows the separation rates of contaminants on the walls of the oil channels from Table 1.

### DETAILED DESCRIPTION

Since it is not possible to completely prevent the presence of contaminants (residues), they are to be deposited during the first operating hours of the engine upstream from control valve 2 in suitably shaped chambers (containments) and remain there for the rest of the engine lifetime. Moreover, the oil channels are to be shaped in such a way that the contaminated oil is primarily guided into residue containments 4 and the separation there is facilitated by low flow speeds.

CFD simulations were carried out to make visible the trajectories of contaminants in the oil flow. In this case, an instantaneous series geometry of an engine as well as a modified geometry having two residue containments according to the present invention were contemplated by way of example.

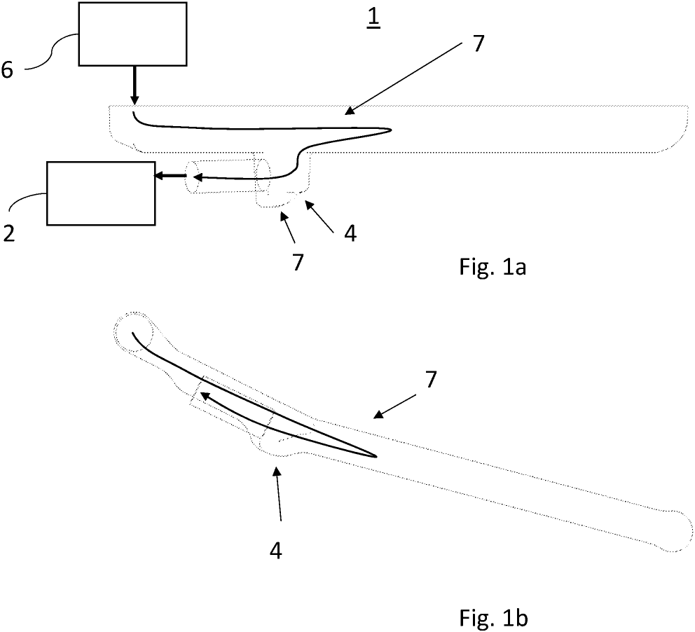

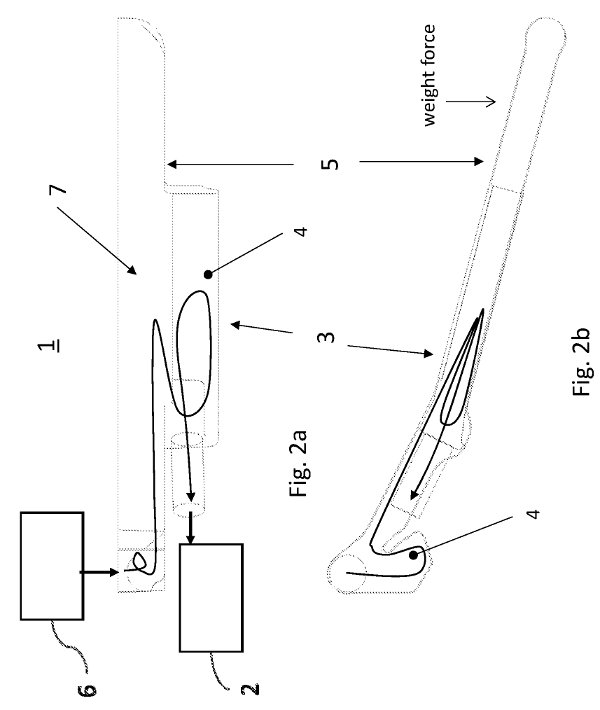

FIGS. 1a, 1b show the trajectories of contaminants (in the present case: steel balls having a diameter of 1 mm) in the oil for an oil channel situated in the crankcase of the internal combustion engine in such a way that the dead end or the appendix of the oil channel is tilted by 20 to 30 degrees versus the horizontal bottom edge of the crankcase, so that the contaminants are able to sink to the bottom in the dead end with the aid of gravity. The internal combustion engine schematically shown in FIGS. 1a, 1b includes a crankcase 1, an oil pump 6, an oil circuit 7, a control valve 2 and a separating device 3 for separating particulate contaminants from a fluid flow from the crankcase 1 of the internal combustion engine. The separating device 3 has a containment 4 for receiving the contaminants. A further exemplary embodiment of the present invention is illustrated in FIGS. 2a, 2b. It shows for comparison purposes the trajectories for a geometry having two residue containments in an oil channel situated in the crankcase of the internal combustion engine in such a way that the dead end or the appendix of the oil channel is tilted by 20 to 30 degrees versus the horizontal bottom edge of the crankcase, so that the contaminants are able to sink to the bottom in the dead end with the aid of gravity. In one specific embodiment (not illustrated), it is also possible to just use one containment 4 in each case.

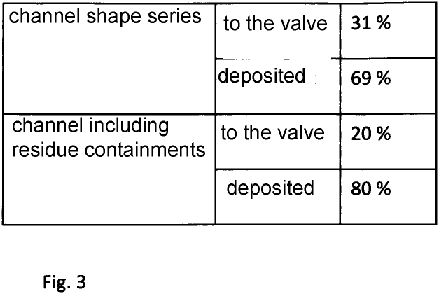

Some of the contaminants deposit themselves on the walls of the oil channels even without residue containments. The comparison of the separation rates in Table 1, which is illustrated in FIG. 3, shows, however, that the separation rates are considerably higher in the presence of the residue containments. Even higher separation rates are possible if further optimized residue containments are used.

### LIST OF REFERENCE NUMERALS

1 crankcase
2 control valve
3 device for separating particulate contaminants
4 containment for receiving contaminants
5 appendix-like oil line or channel
6 oil pump
7 oil circuit

What is claimed is:

1-10. (canceled)

11. An internal combustion engine comprising:
a crankcase;
an oil pump;
an oil circuit;
a control valve; and
a separating device for separating particulate contaminants from a fluid flow from the crankcase of the internal combustion engine, the separating device having a containment for receiving the contaminants.

12. The internal combustion engine as recited in claim 12, wherein the separating device includes at least one appendix-shaped oil line.

13. The internal combustion engine as recited in claim 12, wherein the separating device includes at least one appendix-shaped oil line situated at an angle of approximately 15 to 35 degrees to the horizontal floor of the crankcase, so the contaminants sink to the bottom in the appendix-shaped part of the oil line with the aid of gravity.

14. The internal combustion engine as recited in claim 12, wherein the separating device includes a second containment for receiving contaminants.

15. The internal combustion engine as recited in claim 12, wherein the containment includes an enlarged cross section as compared to an oil line or oil channel.

16. The internal combustion engine as recited in claim 12, wherein the containment is situated lower as compared to an oil line or oil channel, such that contaminants sink to the bottom with the aid of gravity.

17. The internal combustion engine as recited in claim 12, wherein the containment is situated in the oil circuit between the oil pump and the control valve.

18. The internal combustion engine as recited in claim 12 wherein the oil channels are shaped in such a way that the contaminated oil is primarily guided into the containments and the separation there is facilitated by low flow speeds.

19. The internal combustion engine as recited in claim 12 wherein the oil channels are shaped in such a way that the contaminated oil is primarily guided into the containments and the separation there is facilitated by low flow speeds that are generated by larger cross-sections.

20. A method for separating particulate contaminants from a fluid flow originating from a crankcase of an internal combustion engine comprising:
providing the internal combustion engine as recited in claim 12; and
separating particulate contaminants from the fluid flow originating from the crankcase using the separating device.
